(19) United States
(12) Patent Application Publication
(10) Pub. No.: US 2007/0256892 A1
(43) Pub. Date: Nov. 8, 2007

(54) Ladder stand with platform hoist and method of assembling same

(76) Inventor: Michael G. Breedlove SR., Hanna City, IL (US)

Correspondence Address: MAYER BROWN LLP, P.O. BOX 2828, CHICAGO, IL, 60690, US

(21) Appl. No.: 11/429,820

(22) Filed: May 8, 2006

(51) Int. Cl. E06C 7/16

(52) U.S. Cl. 182/116

(57) ABSTRACT

Ladder stand structures having a ladder assembly and a platform assembly which may be secured in a plurality of positions as the platform assembly is raised or lowered in sliding engagement with the ladder assembly, and an enhanced method of assembling such ladder stand structures.

### BACKGROUND OF THE INVENTION

1. Field of the Invention

The present invention generally relates to platforms for participating in activities or working in a raised position relative to the ground. More particularly, the present invention relates to ladder stand structures having a platform which may be secured in a plurality of positions as the platform is raised or lowered and to an enhanced method of assembling such ladder stand structures.

2. Discussion of the Prior Art

Through the years, many devices have been developed to be able to partake in recreation or work at levels above the ground surface. The devices have taken several different forms and typically have been used for activities such as hunting or bird watching from towers or trees, or performing maintenance, such as on telephone, cable television or electrical equipment mounted on utility poles, or on other structures such as municipal lamp posts.

Within the various prior art devices, there generally are three different types. First, there are structures that resemble tripods or towers designed to stand alone on the ground in an open space. Such structures tend to be quite bulky and heavy, given that they must independently provide sufficient stability. They also tend not to provide the sense of camouflage desired by hunters or bird watchers, because they often are not immediately adjacent a tree.

Second, there are devices designed to be used in climbing a vertically standing columnar structure, such as a tree or pole. These devices tend to take two general forms, the first of which are known as a climbing harness or tree stand. Within the category of climbing harnesses or tree stands, the devices are used to both climb and remain suspended during the desired elevated activity. For instance, such devices utilize a climbing harness, by which the user is able to repeatedly reposition the harness relative to a vertically standing columnar structure in order to ascend or descend, and then may remain suspended for a period of time. The climbing harnesses also may be used by utility workers to scale utility poles and then work on telephone, cable or power lines. The harnesses may include tree stands, which are more often used by hunters to climb a tree, and then to construct a perch which extends substantially horizontally outward from the tree and upon which the hunter may sit or stand to conduct hunting activities. Such climbing harnesses or tree stands require significant strength and mobility to use and inherently tend to be on the minimal side in regard to providing surface or working area, support and safety features.

Third, there are devices which are commonly known as ladder stands. Ladder stands typically include both a ladder portion and a seat or platform portion. Prior art ladder stands generally are intended to be assembled in one of two ways. The first method of assembly involves assembling ladder sections while the sections are laying on the ground. A seat or platform is attached near the end of the ladder that will be at the top when the ladder stand is erected. The bottom of the ladder is then placed near a tree. The very top-heavy structure then must be brought to an upright position so as to be leaned against the tree. Unfortunately, with the seat or platform attached to the upper end of the ladder, the device is quite difficult to handle and generally requires a few individuals to be able to raise the device and to eventually strap the device to the tree. Even with a few individuals, it can prove challenging to attempt to lean such a device against a tree, hold it steady and then send an individual up the unsecured ladder to tie the upper end of the device to the tree. Also, some of these devices are constructed in such a way that the user must climb the ladder, and then climb from the ladder around a protruding platform to arrive atop the platform portion. Maneuvering to gain access to the perch on such devices can be less than comforting. Prior art ladder stands further tend to be constructed of narrow, painted square tubing, which does not provide adequate traction for ladder rung tread surfaces.

In a second method of assembly, prior art ladder stands often are assembled by building the ladder vertically, one section at a time. In this way, a user may attach a first ladder section to a tree. Then, the user must lift a second ladder section and carry it upward while climbing the first section. The user then must stack the second section atop the first section, and while attempting to hold onto the ladder, the user then must secure the second ladder section to the tree. This stacking method is repeated to build a ladder of the desired height. Unfortunately, the user tends to be placed in difficult positions because the user must attempt to climb and hold onto the ladder while also lifting the next ladder section and attempting to join the sections and secure them to the tree. In addition, the user then must carry up the ladder a seat or platform and again, while trying to hold onto the ladder, attach the seat or platform to the tree.

Both prior art methods of assembling a ladder stand are time consuming, inconvenient and present many opportunities for accidents or injuries. In fact, it is believed that most injuries to hunters using ladder stands occur due to falls. No greater issue faces the tree stand industry than the issue of hunter safety. Falls from tree stands occur frequently and the resulting injuries can be severe or even fatal. While the industry has made attempts to address such safety issues, most of the solutions offered have serious shortcomings. Indeed, it is still common for falls to occur when the user is assembling or disassembling the ladder stand, or while ascending or descending the ladder. Such injuries are further facilitated because with the prior art devices, the user is not secured to the ladder or tree while assembling the ladder stand or while initially climbing or descending the ladder. Rather, it is common for the user only to tie off to the tree once the user has the ladder stand fully assembled and erected, and has climbed to the top of the device.

Despite the variety of prior art devices, there exists a need for enhanced ladder stand devices for use by hunters and workers in elevated positions relative to a ground surface. It is desirable that such devices may be quickly and conveniently assembled and moved to a position for use adjacent a secure, substantially vertical columnar structure, such as a tree or a pole. It is further advantageous that the devices include a ladder assembly and a platform assembly and that they be constructed in a manner so as to be easily and safely assembled and erected by an individual user. It is desirable that the ladder assembly be relatively light weight for transportation purposes, and include adjustable standoffs so as to permit placement adjacent to a substantially vertical columnar structure while providing contact at various points along the ladder assembly despite the columnar structure having some deviations, such as are common in a tree trunk. It is further desirable that the ladder assembly be constructed in a manner using light weight ladder stiles, and light weight rungs which enhance the rigidity of the ladder, while providing increased tread surface engagement.

Given the shortcomings in the prior art, it also is desirable that the devices include means to securely ascend and descend the ladder assembly, as well as have convenient access to a platform assembly. In this respect, it is desirable that the device have a hoist system to be able to raise the platform assembly while the user stands securely on the ground surface. It is further desirable that the platform assembly have a trolley portion that interacts with the ladder assembly to maintain engagement between the ladder and platform assemblies. It would be advantageous that the platform assembly be pivotable and have supports to place it in a position for use which is substantially perpendicular to the ladder assembly. It would be still further advantageous for the platform assembly to have an opening to allow the user to pass through the platform assembly while ascending the ladder. It also is desirable that such devices additionally have a plurality of working assembly heights, so as to be able to perch at different heights relative to the ground for hunting, working or other activities. It also would be advantageous for the ladder stand to include safety systems to permit the user to be connected at all times to the ladder stand and to support the user in the event of a fall. It is desirable that such safety systems would include a harness to be worn by the user which permits normal movement in ascending and descending the ladder assembly while securing the user to the ladder assembly. It also would be desirable that such safety systems would include a retractable, fall arresting safety belt attachable to the user's harness which would permit relatively free movement while atop the platform assembly and enable the user thereafter to ascend and descend the ladder assembly while continuously connected to the fall arresting safety belt.

The present invention addresses shortcomings in prior art devices developed to be used for recreation or work at levels above the ground surface, while providing in various combinations many or all of the above mentioned desirable features.

### SUMMARY OF THE INVENTION

The purpose and advantages of the invention will be set forth in and apparent from the description and drawings that follow, as well as will be learned by practice of the invention.

The present invention is generally embodied in a ladder stand assembly that is modular in construction and may be safely and conveniently assembled by a single person. The ladder stand assembly combines a ladder assembly and a platform assembly with the platform assembly engaging the ladder assembly and being movable to an elevated position for use. The ladder stand assembly of the present invention has numerous desirable features that overcome shortcomings in prior art ladder stand assemblies, as well as an advantageous method of assembly.

In a first aspect of the invention, a ladder assembly is provided that has at least one ladder section, and the ladder section includes two spaced apart, substantially parallel stiles and a plurality of spaced apart rungs spanning between and connected to the respective two spaced apart stiles. Each rung of the ladder assembly has a configuration that further includes at least a tread portion, a rear support portion connected to the tread portion and connected to the stiles, and a front portion connected to the tread portion and having two pair of separate spaced apart tab portions with each pair being connected to a different one of the respective stiles.

In a further aspect of the invention, a ladder stand assembly is provided that has a ladder assembly and a platform assembly, where the platform assembly further includes a trolley assembly having a frame substantially parallel to the ladder assembly and being pivotally connected to a deck assembly. The trolley assembly slidably engages the ladder assembly and is configured to be hoisted upward and along the ladder assembly, and the platform assembly has a locking assembly to adjust the position of the platform assembly relative to the ladder assembly.

In another aspect of the invention, a ladder stand assembly is provided that has a ladder assembly and a platform assembly, with the platform assembly being removably connectable to the ladder assembly and adjustable to a plurality of positions along the length of the ladder assembly. The platform assembly further includes a deck assembly having a deck surface and an opening in the deck surface coverable by a door assembly, wherein the door assembly is movable between a closed position and an open position to permit access to the deck surface through the opening.

In still another aspect of the invention, a ladder assembly is provided that has at least one ladder section having a length and a plurality steps located in a first plane and a plurality of spacer assemblies arranged along the length of the ladder section and extending away from the first plane. Each spacer assembly further includes a pair of pivotally adjustable arms movable to at least two positions in which the arms are oriented in crossed configurations relative to each other, wherein each arm intersects the respective path of the other arm and the two positions establish at least two spacer adjustment settings having different distances between first plane and the intersection of the crossed arms.

In yet another aspect of the invention, a ladder assembly is provided with a fall arrest system that includes a user climbing harness having at least one tether line extending from the harness and having a fastener at the distal end of the tether line. The ladder assembly further includes at least one ladder section, the ladder section further including at least one ladder stile and a plurality of spaced apart ladder steps connected to the at least one ladder stile. The at least one ladder section has a length and further includes fastener engaging positions along its length that receive at least one tether line fastener, and the user wearing the climbing harness is able to engage the at least one tether line fastener with successive fastener engaging positions on the at least one ladder section while ascending or descending the ladder section.

In and additional aspect of the invention, a method of assembling a ladder stand assembly is provided where the method includes the steps of connecting a plurality of ladder sections having spacer assemblies and steps to form a ladder assembly having a length along a ground surface, making preliminary adjustments to the spacer assemblies on the ladder assembly, connecting binding assemblies to the ladder assembly to permit connection to a columnar structure, moving the ladder assembly from along the ground surface to a relatively vertical position immediately adjacent the columnar structure, binding the ladder assembly to the columnar structure with the binding assemblies that are reachable by a user from the ground surface, climbing the ladder assembly while removably connecting a harness worn by the user to the ladder assembly to reach successively higher binding positions and to further bind the ladder to the columnar structure at all successively higher positions, descending the ladder assembly, connecting to the ladder assembly a platform assembly having a trolley assembly pivotally connected to a deck assembly and slidably engaged with the ladder assembly, hoisting the platform assembly to a desired height corresponding to a height of one of the steps, climbing the ladder assembly and pivoting the deck assembly relative to the trolley assembly and connecting at least one support mechanism to maintain one or more angular positions of the deck assembly relative to the trolley assembly, adjusting the support mechanism to achieve a desired angular position of the deck assembly relative to the trolley assembly, and separately binding the platform assembly to the columnar structure with a binding assembly.

Thus, the present invention presents an alternative to the prior art raised platform devices and methods of assembling them. It also simplifies the assembly of the components to permit a single person to assemble and erect an entire ladder stand safely and without assistance.

It is to be understood that both the foregoing general description and the following detailed description are exemplary and provided for purposes of explanation only, and are not restrictive of the invention, as claimed. Further features and objects of the present invention will become more fully apparent in the following description of the preferred embodiments and from the appended claims.

### BRIEF DESCRIPTION OF THE DRAWINGS

In describing the preferred embodiments, reference is made to the accompanying drawing figures wherein like parts have like reference numerals, and wherein:

FIG. 1 is a perspective view of a user joining sections of a ladder assembly of a first embodiment consistent with the present invention.

FIG. 2 is a perspective view of a spacer assembly of a binding system and a more detailed view of a tread of the first embodiment.

FIG. 3 is a perspective view of a user having donned a safety harness and positioning the ladder assembly of the first embodiment adjacent the base of a tree.

FIG. 4 is a perspective view of a user raising the ladder assembly of the first embodiment into a substantially vertical position against the tree.

FIG. 5 is a perspective view of a user engaging a binding system of the first embodiment to connect the ladder assembly to the tree.

FIG. 6 is a perspective view of a user tethered to the ladder assembly by a safety harness consistent with the present invention and after having completed the connection of the ladder assembly to the tree.

FIG. 6A is a perspective view of an alternative eyelet formed along the inside surface of a stile which may be used to tether a user to the ladder assembly.

FIG. 7 is a perspective view of the user preparing to connect a trolley portion of a platform assembly to the ladder assembly of the first embodiment, adjacent the ground surface.

FIG. 8 is a perspective view of a user hoisting the platform assembly up the ladder assembly of the first embodiment, to attain a desired elevated platform position.

FIG. 9 is a perspective view of a user pivoting the platform portion relative to the trolley portion and moving a support rod assembly of the first embodiment to a support position.

FIG. 10 is a perspective of a user passing through an opening in the platform portion of the first embodiment.

FIG. 11 is a perspective view of an assembled ladder stand of the first embodiment.

FIG. 11A is a closer perspective view of a level connected to the platform assembly.

FIG. 12 is a side view of a support element for a deck assembly.

FIG. 12A is a perspective view of the adjustment mechanism for the support element shown in FIG. 12.

FIG. 12B is a perspective view of an alternative embodiment of an adjustment mechanism for the support element shown in FIG. 12.

FIG. 13 is a side view of an alternative embodiment of a support element which uses an adjustable, folding support rod.

FIG. 14 is a perspective view of the adjustable, folding support rod shown in FIG. 13 but with a collar shown in phantom in a locking position.

FIG. 15 is a front view of a double seat assembly installed on a ladder stand consistent with the invention.

FIG. 16 is a simplified perspective view of an alternative embodiment of a platform assembly, with two separate doors and the platform portion pivoted downward relative to and having the outer edge hanging from a portion of a frame of an alternative trolley assembly.

FIG. 17 is a perspective view of a schematic representation of an alternative embodiment of a ladder assembly that has pivotally connected sections and an optional wheel assembly for ease of transporting the ladder stand.

FIG. 18 is a perspective view of a simplified portion of a further alternative embodiment of a ladder stand having a single, central vertical stile or ladder rail.

FIG. 19 is a perspective view of the alternative embodiment shown in FIG. 18 with a seat provided and a more complete platform having a sliding door assembly.

FIG. 20 is a perspective view of a seat assembly for attachment to a ladder assembly of the first embodiment.

It should be understood that the drawings are not to scale and provide examples involving ladder stand assemblies that may be constructed in many different ways while still being consistent with the scope and spirit of the present invention. While some mechanical details of a ladder stand assembly, and other plan and section views of the particular components, are not shown, such details are considered well within the comprehension of those skilled in the art in light of the present disclosure. It also should be understood that the present invention is not limited to the preferred embodiments illustrated.

### DETAILED DESCRIPTION OF THE PREFERRED EMBODIMENTS

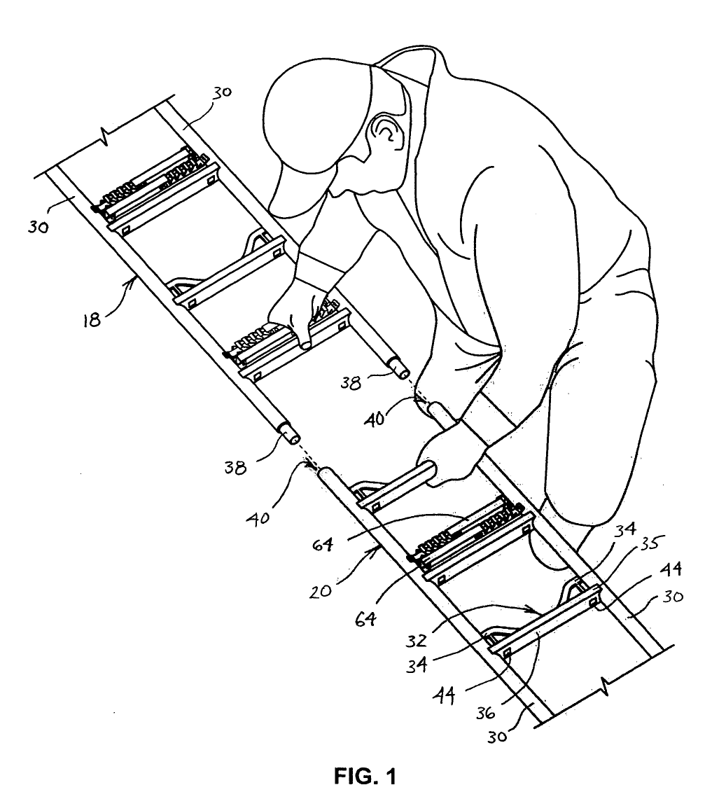

Referring generally to FIGS. 1-20, the ladder stand of the present invention provides numerous highly advantageous features and may be embodied in various configurations. It will be appreciated that the ladder stand of the present invention is essentially modular in construction and intended for convenient and safe installation by a single person. Regardless of the particular embodiment chosen, in general, the system combines a ladder assembly and a platform assembly. The platform assembly engages the ladder assembly and may be moved relative to ladder assembly to an elevated position for use.

As seen in reference to the first embodiment, shown in FIGS. 1-12, a ladder stand 10 is constructed of a ladder assembly 12 and a platform assembly 14. Ladder assembly 12 preferably is constructed of multiple ladder sections, which are shown by example as three ladder sections 16, 18, 20. It will be appreciated that the ladder assembly may be constructed of one or more sections, each of any desired and practical length. In the preferred embodiment, the ladder sections 16, 18, 20 are shown as being five feet in length, primarily for ease of transportation and handling. With such a modular design, multiple ladder sections may be connected together to attain an appropriate usable height, with the potential of attaining significant elevated positions.

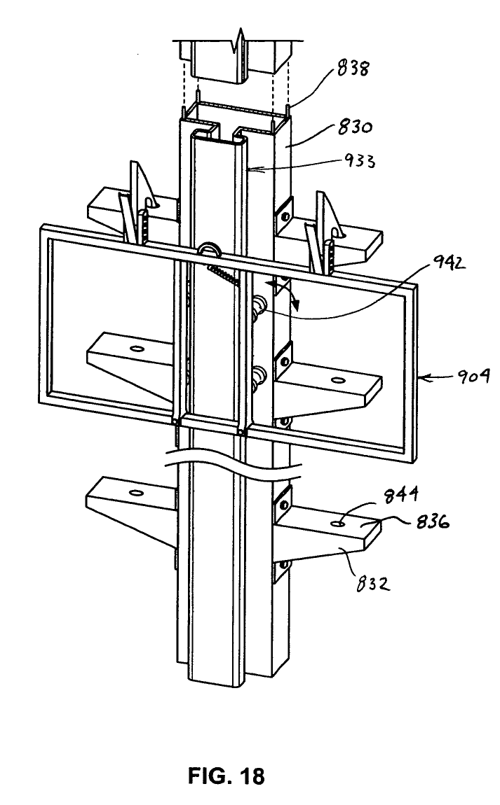

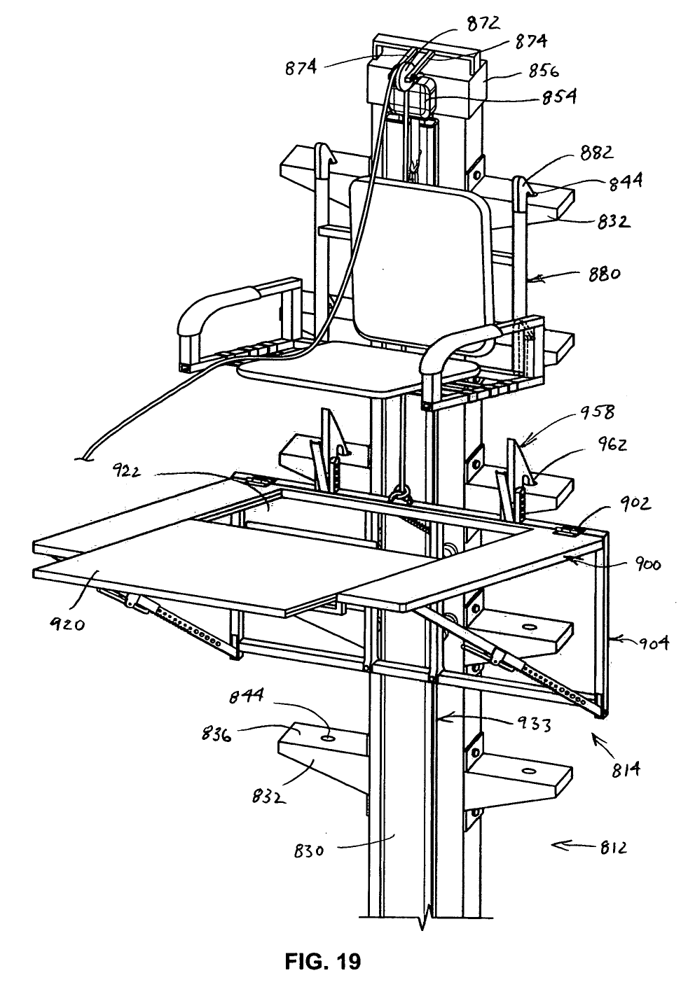

In the preferred embodiment, each ladder section is constructed of a pair of outer rails or stiles 30, and a series of steps or rungs 32. While the preferred embodiment employs circular steel tubing for stiles 30, alternative shapes and materials may be used. For instance, it is desirable that the ladder stiles be relatively rigid, thus one may use materials such as other metals, plastics, resin-based products, or the like. In particular, for utility service applications, the non-conductive properties of plastics may be highly desirable. Also, various stile configurations, such as circular or square tubing, I-beam or channel sections, or other custom configurations may be suitable, as well as the use of a single central stile or spine member, as shown by example and described further below in relation to FIGS. 18 and 19.

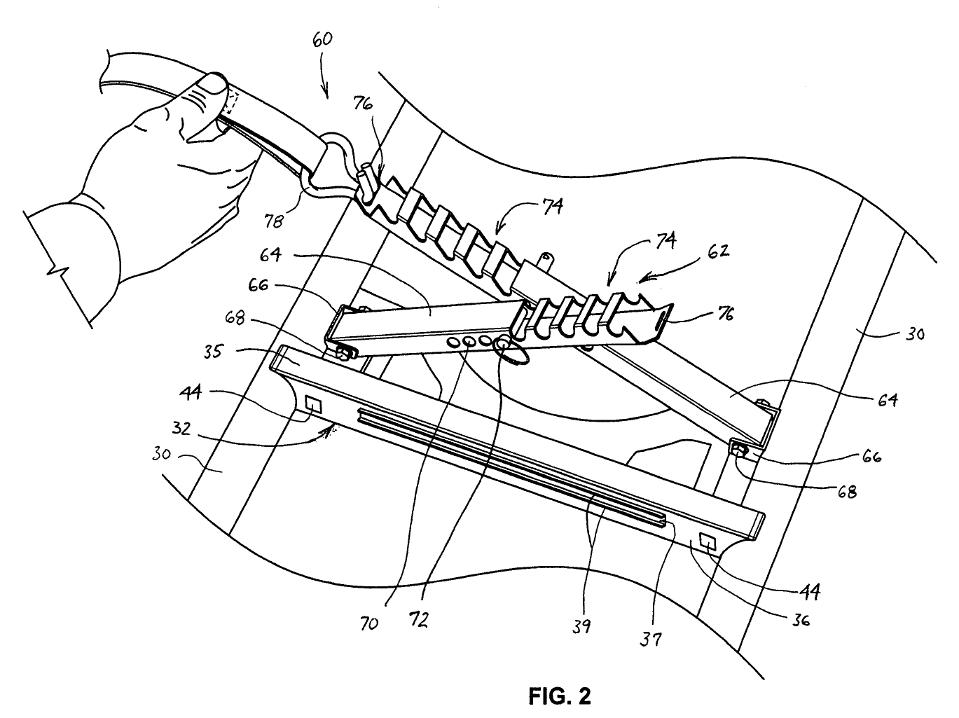

Rungs 32 are shown as having a unique and advantageous cross-shaped configuration of a front face or portion 33. The cross shape minimizes material use while providing a broad mounting pattern by using a pair of upper and lower tabs 34 on each side. The increased front face length and connection points allow for enhanced connection to the stiles, whether by welding or fasteners. This, in turn, reduces ladder weight and provides increased rigidity of each rung, as well as of the ladder in general. This unique type of rung also includes a rear support portion 35, and provides a larger upper surface or tread portion 36. The larger surface of tread portion 36 permits unique tread patterns to be cut or pressed into the upper surface of each rung, as shown by example in more detail in FIG. 2 where in forming a slot 37, the metal is pressed upward, resulting in edges 39 which provide enhanced traction. For simplicity, the other views of rungs 32 will be shown without slot 37 and edges 39. In the preferred embodiment, rungs 32 are constructed of stamped sheet steel. However, as with the ladder stiles 30, it will be appreciated that alternative configurations, including more standard tubular rungs, and various materials may be used for stamping, molding or otherwise forming steps or rungs.

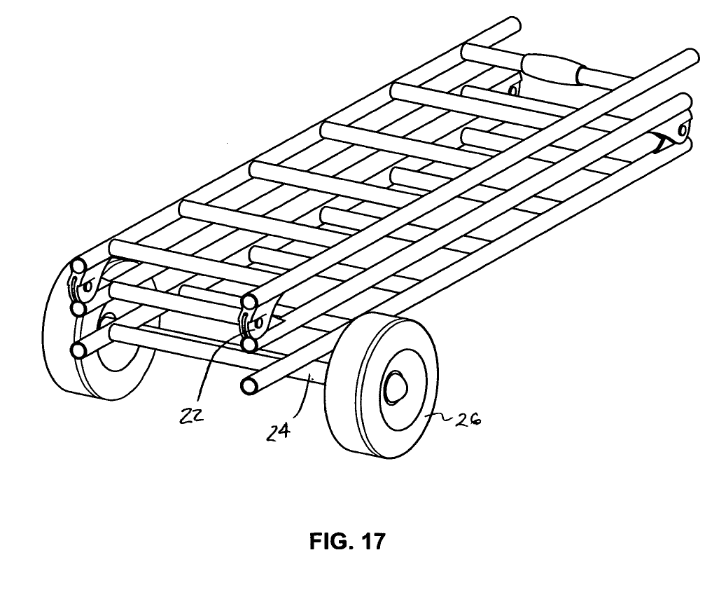

The ladder sections may be joined in numerous ways. For instance, FIG. 1 represents two joining structures. First, stile ends 38 could be formed by fixedly attaching inserts, such as short pieces of smaller diameter tubing, in the upper ends of stiles 30 of middle ladder section 18, such as by fasteners, adhesives or the like. Alternatively, stile ends 38 of middle ladder section 18 may simply have a necked down, reduced diameter portions of stiles 30. By use of either of such smaller diameter stile ends 38, middle ladder section 18 may be conveniently joined to upper ladder section 20 by slidably engaging smaller diameter stile ends 38 with corresponding open lower ends 40 of the stiles 30 of upper ladder section 20. Lower ladder section 16 and middle ladder section 18 may be joined in a similar manner. It will be appreciated that there may be many different sectioned ladder configurations, and even an alternative folding ladder configuration, as is schematically shown in FIG. 17 may be used with a ladder having other desirable features of the present invention. Thus, the ladder sections of the first embodiment may be pivotally connected by couplings 22, and an axle 24 and wheels 26 may be connected to at least one ladder section in various ways for ease of transporting ladder stand 10.

The ladder assembly of the present invention also may incorporate safety systems to permit the user to climb up and down the ladder while being safely tethered to the ladder to prevent falls. To do so, the user dons a safety harness 42, which may be of various configurations, but which should be able to suspend the user by a safety line attached to the harness. The preferred embodiment employs two different safety systems that are particularly advantageous.

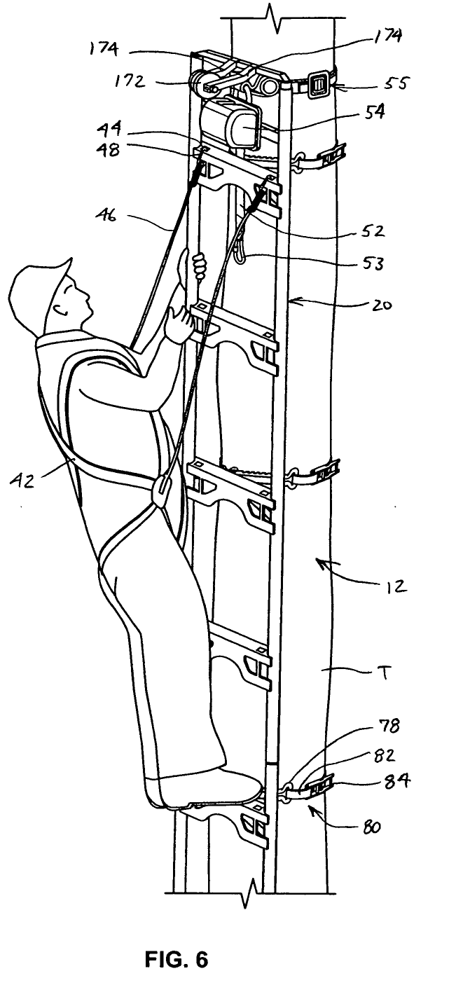

With respect to the first safety system, each rung 32 has a pair of slots or holes 44 toward the outer ends of tread portion 36. Holes 44 have multiple uses in this embodiment, one of which is with respect to the first safety system. In particular, harness 42 has a pair of safety lines 46 connected to and extending from the sides of harness 42, with each safety line 46 having a hook 48 at its distal end. Safety lines 46 are shown as a length of rope, but may be constructed of any suitable flexible material, such as rope, cable, webbing, chain or the like. To ensure the user is never in danger of falling to the ground once on ladder assembly 12, while the user is ascending or descending ladder assembly 12, the user may place each hook 48 in successive rung holes 44 while passing from one rung to the next. For example, as shown in FIG. 6, hooks 48 are engaged in holes 44 in a rung 32 that is four positions higher than the rung on which the user is standing. This first safety system provides the ability for the user to remove the user's hands from ladder assembly 12 and lean back into tethered harness 42, to free the user's hands for other tasks, as needed. It will be appreciated that alternative connecting structures may be used for hooks 48, as well as for the hook receiving connectors and locations on ladder assembly 12. One example is shown in FIG. 6A, where an eyelet 50 is formed on the inner wall of a stile 30 by welding a steel rod portion to the stile. Such free standing eyelets 50 would permit use of hooks 48 or alternatively, self-locking clips.

From the position shown in FIG. 6, it will be appreciated that if the user wanted to climb upward from the position shown, the user would grasp a ladder stile or rung and step upward to the next higher rung, then move hook 48 to a hole 44 in the next higher rung 32 for each respective side, and continue to repeat the process as the user climbs. Alternatively, if the user wished to descend, the user would grasp a ladder stile or rung, lean toward the ladder so as to slacken safety line 44, grasp a hook 48 and move it to a hole 44 in the next lower rung 32, and then step downward to the next lower rung. This would be repeated with respect to each side as the user descends the ladder.

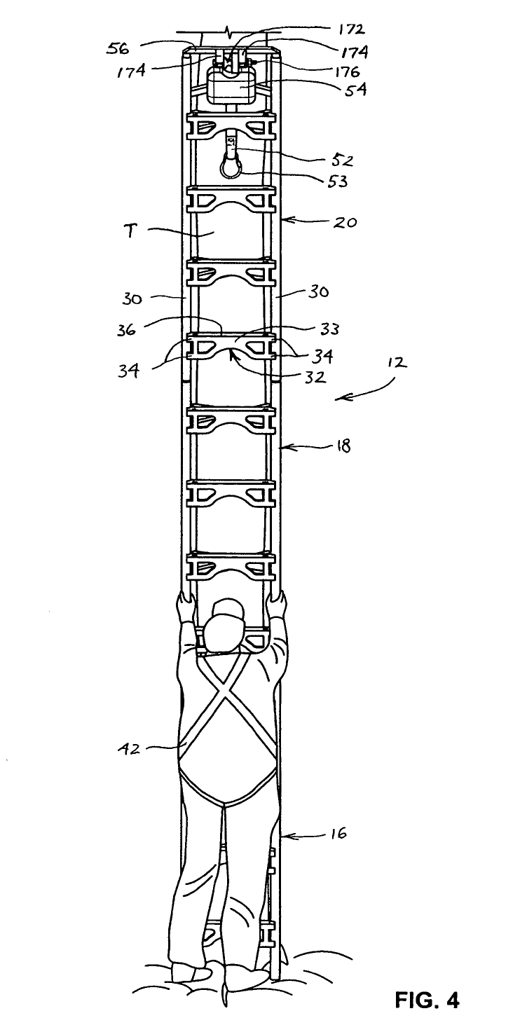

The second safety system also utilizes the user's safety harness 42, but additionally includes a fall arrest belt 52 and belt retractor 54. Belt 52 may be constructed in various ways and of any suitable material, and in the preferred embodiment, resembles a safety belt that would commonly be used in an automobile. However, belt 52 is considerably longer, so as to be able to be reach the ground and a reasonable perimeter around ladder stand 10, and includes a connector 53 to connect to the user's harness 42. Belt retractor 54 is of a commercially available type, such as are sold by Integrated Safety Systems, which uses a catch mechanism that responds to a sudden movement, such as in the event of a fall, and stops rotation of the spool on which belt 52 is wound. As seen in FIG. 4, belt retractor 54 preferably is connected to ladder assembly 12 at a cross bar 56. Cross bar 56 is mounted proximate the upper end of ladder section 20. It will be appreciated that belt retractor 54 may be connected to upper ladder section 20 in alternative ways, such as by being connected to one of the rungs or stiles. Belt retractor 54 also may be separately connected to the columnar structure or tree T as shown with a separate belt assembly 55. In any event, once the user has installed ladder stand 10, as will be discussed in greater detail below, the user may climb to the top of the ladder assembly 12 and connect fall arrest belt 52 to the user's harness 42 with connector 53. The user then may move about in a normal manner, and may climb up and down the ladder and move within a predetermined distance of the tree or other vertical structure to which the ladder stand is connected. However, if at any time belt 52 is subjected to a rapid movement, such as when falling, belt retractor 54 will prevent belt 52 from extending further and thereby stop the user's fall.

To connect ladder assembly 12 to a columnar structure, such as a tree or pole, ladder assembly 12 incorporates a binding system 60 which utilizes adjustable stand-off assemblies or spacers 62. Spacers 62 are adjustable and are used to allow ladder assembly 12 to stand in a relatively vertical position adjacent and contacting a tree or pole at various points along the height of ladder assembly 12. The adjustability of spacers 62 permit a user to essentially place ladder assembly 12 in a straight orientation, which most commonly also would be substantially vertical or plumb, while engaging a tree that is not plumb or has slight deviations in its trunk.

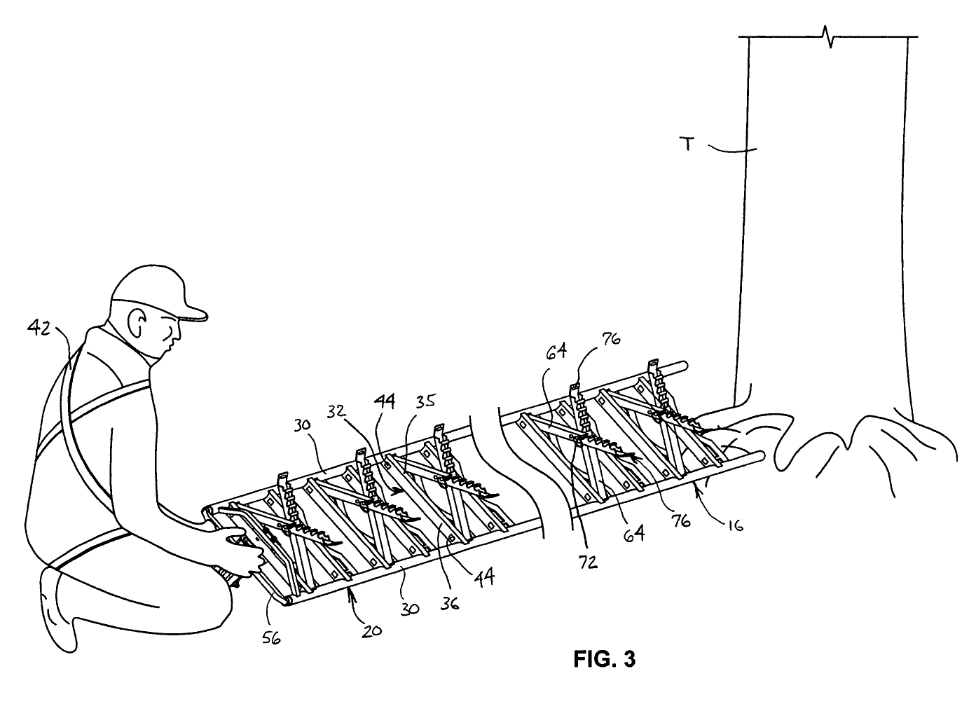

As best seen in FIGS. 2 and 3, a particular cross-bar configuration is preferred for spacers 62. Spacers 62 have a pair of arms 64, each of which is pivotally connected to a ladder stile 30 by a bracket 66 and fastener 68. Each arm has apertures 70 therethrough to receive a locking pin 72. At any particular spacer 62 along the length of ladder assembly 12, the distance between a columnar structure, such as a tree, and ladder assembly 12 can be accounted for, within a reasonable range, by placement of pin 72 through the corresponding apertures 70 in arms 64. Each pin 72 may be tethered to ladder assembly 12 for convenience, such as by a wire. Also, each pin 72 could be configured to use a structure in which pin 72 is a biased toward an engagement position, but able to be disengaged for adjustment purposes. When spacers 62 are not in a deployed position for use, they pivot to a compact storage position, as shown in FIG. 1, between stiles 30.

Spacers 62 play an important role in the binding system 60 for the user to be able to temporarily secure ladder assembly 12 to the columnar structure, such as tree T. Arms 64 are shown as being constructed of steel square tubing, with angled cuts to form teeth 74. It will be appreciated that alternative arm structures, such as of U-shaped channel, and various materials could be used. Also, alternative ways of establishing engagement surfaces may be employed, as desired. For example, for a ladder assembly that is to be used for engaging a tree, many different roughed surfaces could be formed on arms 64. However, if for instance a ladder assembly will be used for engaging a concrete pole, then rubber pads or other suitable materials may be substituted for the engagement points along arms 64.

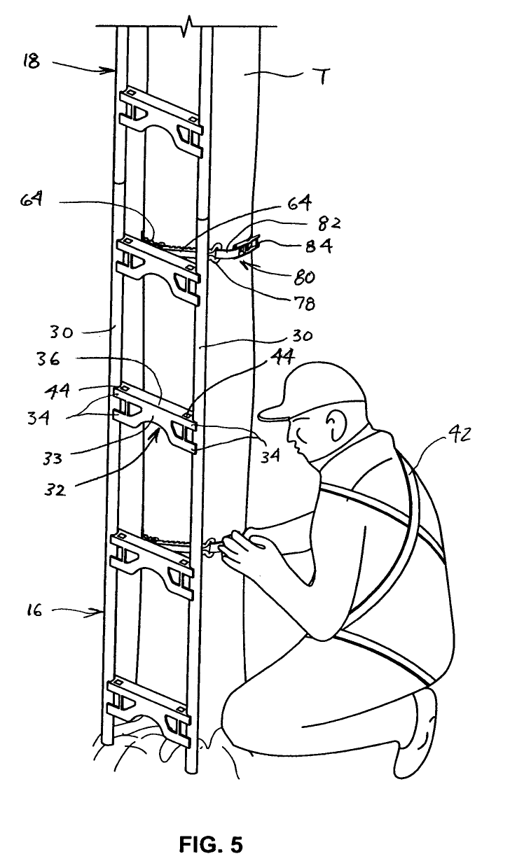

In addition, as best seen in FIGS. 2 and 3, at the end of each arm 64 is a slot 76 for receipt of a hook 78 of an adjustable length flexible assembly 80. In the preferred embodiment, as shown in FIG. 5, adjustable length flexible assembly 80 is shown as a commonly available ratchet strap having a hook 78 at each end of strap portions 82 which engage a ratchet mechanism 84 to adjust the relative length of adjustable strap assembly 80 from end to end. In this manner, a hook 78 is inserted in one slot 76 of a first arm 64 and the strap portions 82 and ratchet mechanism 84 are passed behind tree T to permit the hook 78 at the opposite end to be inserted into corresponding slot 76 in the other arm 64. Then, the user manipulates ratchet mechanism 84 in the commonly known manner to tighten adjustable length flexible assembly 80 and thereby bind ladder assembly 12 to tree T at the respective spacer 60. One of skill in the art will appreciate that other binding systems and spacers may be used, and that the adjustable length flexible assembly 80 may utilize rope, cable, chain or other flexible elements in place of straps, and may be otherwise connected to ladder assembly 12 such as directly to the rungs and/or to one or more stiles.

Ladder stand 10 also includes a platform assembly 14 which ideally incorporates numerous advantageous features. In the example shown in the preferred embodiment, platform assembly 14 is constructed with a deck assembly 100 pivotally connected at pivots 102 along an upper portion of a trolley assembly 104. Deck assembly 100 includes an outer frame 110, frame rails 112 and decking 114 which forms an upper deck surface.

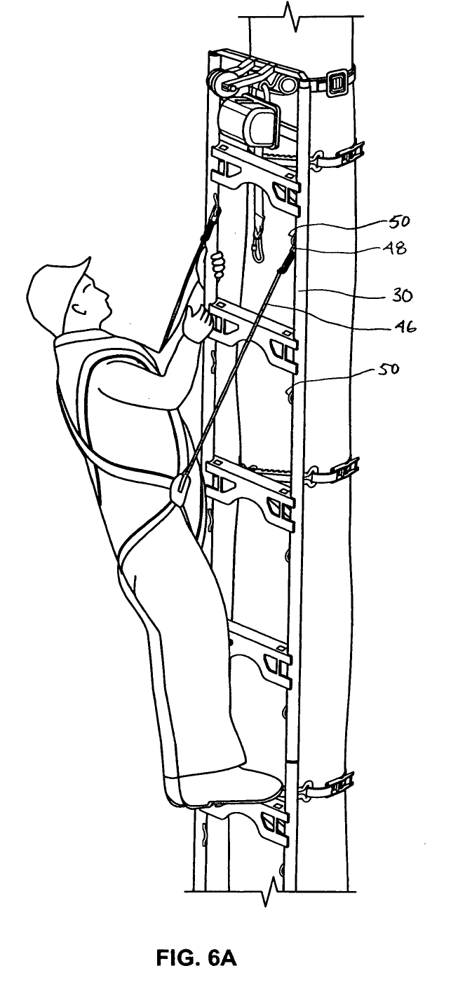

Trolley assembly 104 includes a frame 140 and is intended to engage ladder assembly 12 so as to permit the entire platform assembly 14 to be connected in sliding or rolling engagement with ladder assembly 12 while being moved up or down along stiles 30. In the preferred embodiment, a pair of rollers 142 are rotatably mounted to rails 144 of trolley frame 140, and a second pair of rollers 146 are mounted to arm 148 which is pivotally mounted at pivot 150. The spacing between rollers 142 on rails 144 and rollers 146 on arm 148 is selected so as to allow the respective rollers 142, 146 to be parallel and roll along the outer surface of the respective stiles 30 when platform assembly 14 is connected to ladder assembly 12. To removably connect trolley assembly 104 to stiles 30 of ladder assembly 12, arm 148 is pivoted to permit the spacing between rollers 142 and 146 to be temporarily increased, as shown in FIG. 7. Arm 148 is biased to the position of having rollers 146 lie in a plane parallel to rollers 142 by use of a spring 152. Upper stop 154 and lower stop 156 also may be used to limit the pivotal travel of arm 148.

Trolley assembly 104 also has a pair of rung lock mechanisms 158 pivotally mounted to frame 140. Rung lock mechanisms 158 are spaced apart to so as to be in alignment with holes 44 through tread portion 36 of rungs 32. Each rung lock mechanism 158 is adapted to be able to slide upward over the front face of a rung 32 and then move back downward to engage a locking tab 160 in a corresponding rung hole 44. This structure permits trolley assembly 104 to be raised and locked into position at each successive rung 32. Each rung lock mechanism 158 also has a pivotally mounted blocking latch 162 which is biased toward locking tab 160. When trolley assembly 104 is being raised relative to ladder assembly 12, blocking latches 162 engage the face of rungs 32 and are momentarily forced to pivot downward to an open position, which permits locking tabs 160 to engage rung holes 44. In contrast, when trolley assembly 104 is raised from such a locked position to be sufficiently above a rung 32 to release blocking latches 162, then blocking latches 162 pivot toward a closed position and prevent locking tabs 160 from engaging rung holes 44 as trolley assembly, and therewith platform assembly 14, are lowered past successive rungs 32.

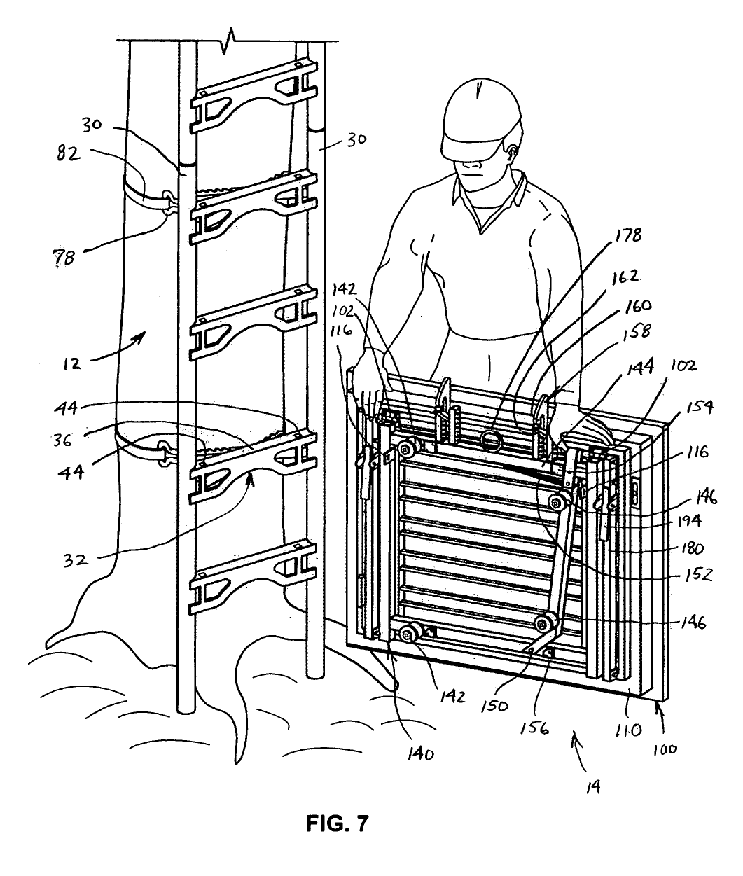

As best seen in FIGS. 7 and 8, for a user to raise platform assembly 14 along ladder assembly 12, arm 148 on trolley assembly 104 is pivoted outward to permit increased spacing between rollers 142 and 146. The platform assembly 14 is moved into position to locate the respective rollers along the outside surfaces of stiles 30, and then arm 148 is released. Trolley assembly 104 is thereafter in sliding engagement relative to ladder assembly 12. A flexible element, such as rope 170 may be strung over a rotatable pulley 172 mounted by at least one arm 174 and an axle 176 proximate the upper end of ladder assembly 12. This may be done prior to erecting ladder assembly 12, or after the user has completed the binding of ladder assembly 12 to the columnar structure, such as tree T. The flexible element 170 is then connected to platform assembly 14, such as at a loop 178 on trolley frame 140. It will be appreciated that any flexible, relatively strong material, such as webbing, cable, chain or the like, may be used in place of rope 170, and although unnecessary for relatively light weight platform assemblies, it will be appreciated that one may utilize multiple pulleys for enhanced mechanical advantage by the well known method of employing a block and tackle arrangement. In the preferred embodiment shown, with rope 170 in place, the user may stand firmly on the ground and simply pull downward on rope 170 to raise platform assembly 14. As platform assembly 14 is raised, it may be stopped and locked into any rung 32 by locking tabs 160.

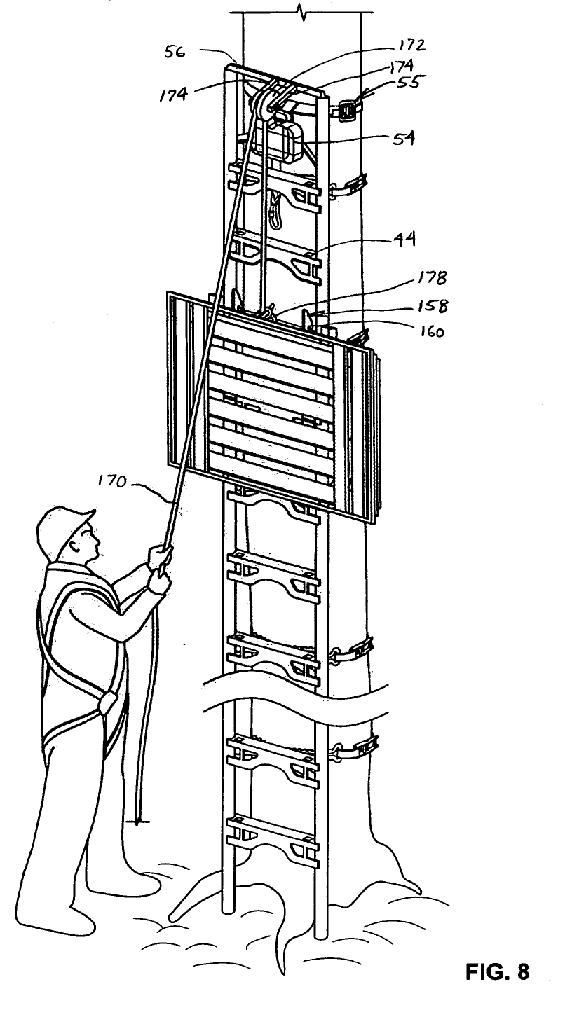

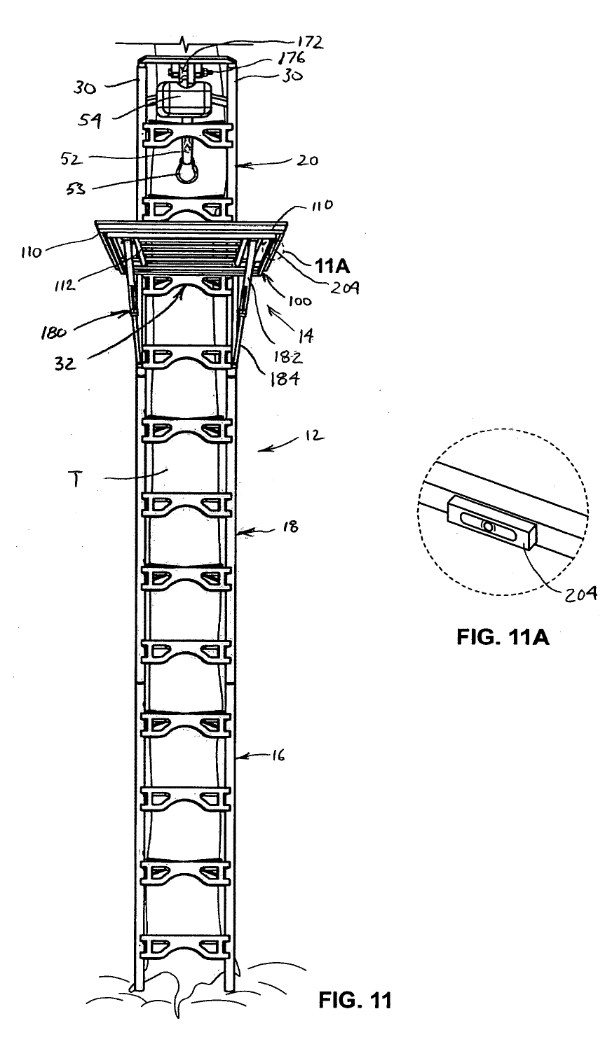

Once platform assembly 14 is raised to a desired height, deck assembly 100 may be pivoted about pivots 102 from its essentially vertical position parallel and adjacent to trolley assembly 104 to a desired position, such as substantially horizontal, or perpendicular to trolley assembly 104. In this manner, as shown in FIG. 9, deck assembly 100 may be moved to a position roughly perpendicular to ladder assembly 12, or to another desired angular position relative thereto. In the preferred embodiment, deck assembly 100 is then supported in the desired position by moving a pair of support elements 180 into position. Such support elements are shown in various configurations in FIGS. 12, 12A, 12B, 13 and 14.

In FIGS. 9, 11 and 12, a support element 180 is shown as a two-piece, adjustable gusset assembly, including slidably engaged tube 182 and rod 184 having a plurality of teeth 186. Tube 182 is pivotally connected to deck assembly 100 at pivot 188. Support elements 180 nest along frame rails 112 of deck assembly 100 when platform assembly 14 is being raised along ladder assembly 12. When deck assembly 100 is pivoted to a use position, support elements 180 may be moved downward and to an angled position to support deck assembly 100. When each support element 180 is pivoted downward, toothed rod 184 may be slidably extended from tube 182, and the end of toothed rod 184 is inserted into a slot 190 in trolley frame 140. Once placed into slot 190, a pin 192, which is shown in FIG. 12 preferably with a cable for convenience, may be place through apertures in trolley frame 140 and the distal end of toothed rod 184 to secure support element 180 in place.

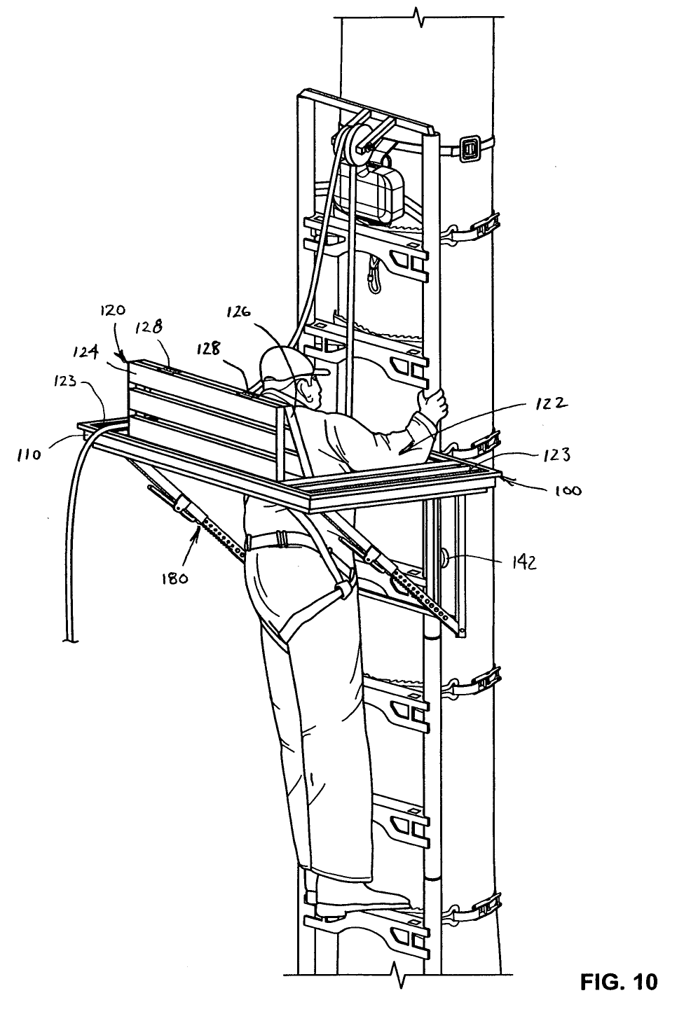

As best seen in FIGS. 12 and 12A, each support element 180 also includes a locking lever 194 with a single tooth 196 that will engage the teeth 186 of rod 184. Locking lever 194 is pivotally mounted at pivot 198 between flanges 200 which are connected to tube 182. Locking lever 194 also is biased, such as by a coil spring 202, to a position of engagement between tooth 196 and the teeth 186 of toothed rod 184. With this structure, once support element 180 is secured with pin 192, deck assembly 100 may be pivoted upward to a final desired use position. During this pivoting of deck assembly 100, toothed rod 184 is automatically extended from tube 182 to reach a final support position. For ease of use in establishing the angular position of deck assembly 100 relative to the ground surface, a level 204 is mounted as shown in FIG. 11A along a frame rail 112. Level 204 is preferably of the common bubble sight type and may be fixedly or removably mounted essentially anywhere along the understructure of deck assembly 100. However, to be most effective, level 204 should be mounted so as to be conveniently viewed by the user when standing on ladder assembly 12 below deck assembly 100. Also, level 204 preferably should be oriented substantially perpendicular to the axis through pivots 102 and in a plane parallel to that of the upper surface of deck assembly 100.

An alternative support element 280 is shown in FIG. 12B. In this alternative, a similar tube 282 and toothed rod 284 are used, and a locking lever 294 is pivotally mounted at a pivot 298 between flanges 300. However, locking lever 294 is biased by a leaf spring element 302, and an auxiliary cabled safety pin 304 is provided which may be inserted through apertures 306 in flanges 300, between locking lever 294 and tube 282, to block movement of locking lever 294. This added safety pin 304 prevents any movement of deck assembly 100 in the event of inadvertent contact with locking lever 294.

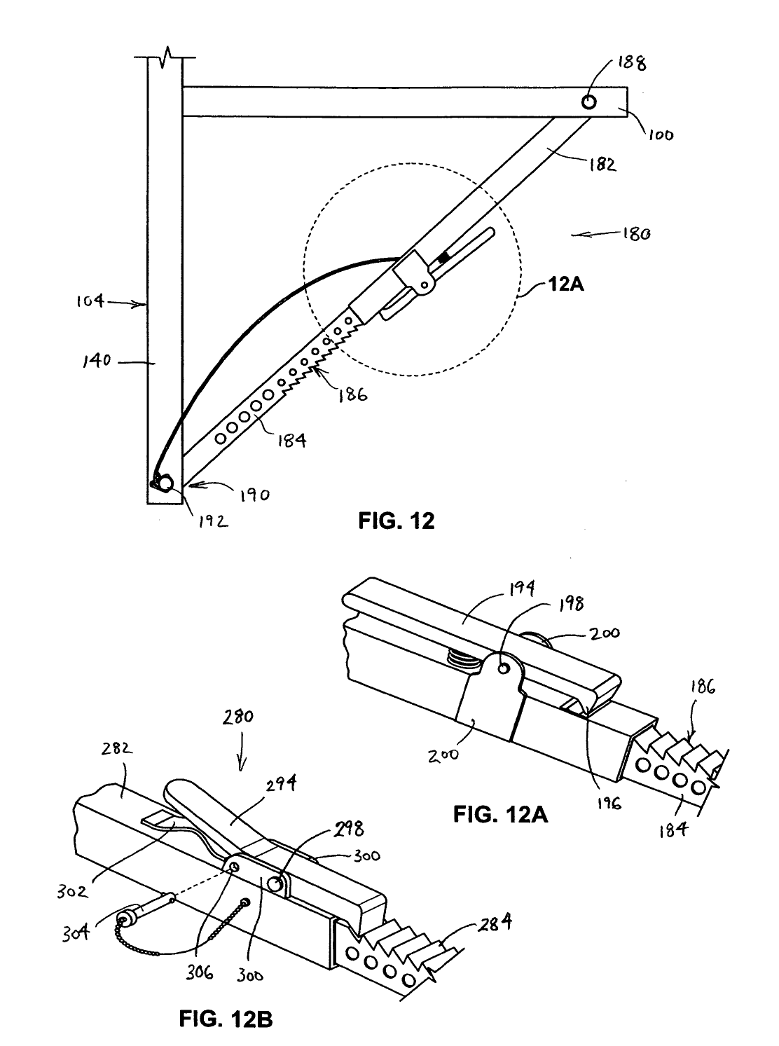

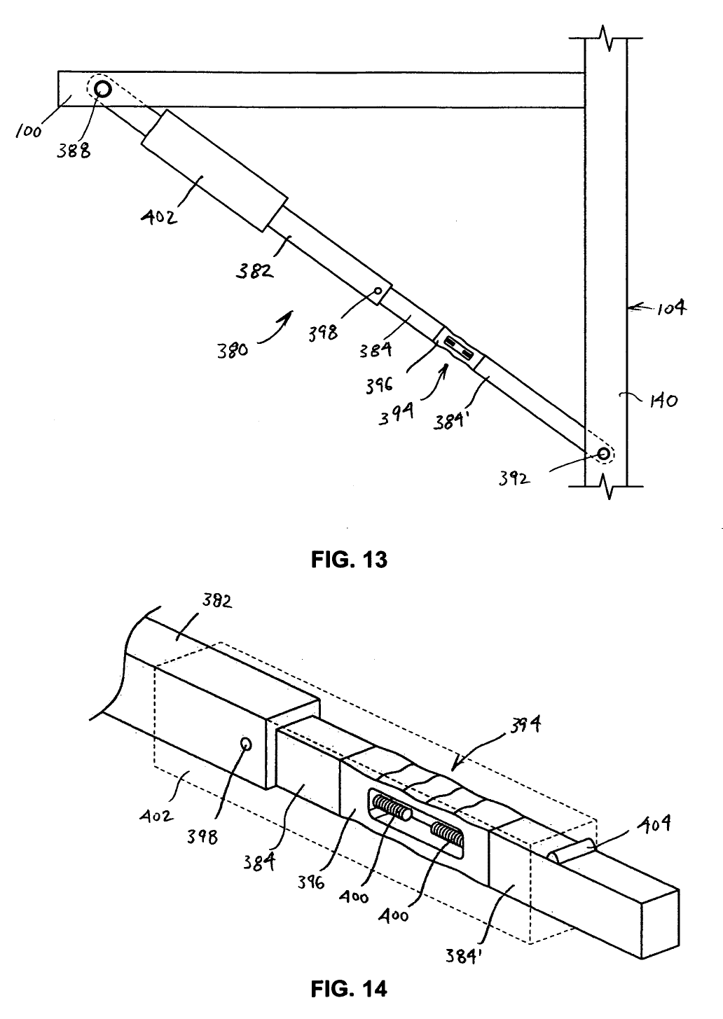

A further alternative embodiment of a support element 380 is shown in FIGS. 13 and 14. In this alternative, a U-shaped channel 382 is pivotally connected at an upper end to deck assembly 100 at pivot 388, and at a lower end to a first bar 384 at pivot 398. First bar 384 is, in turn, connected to a second bar 384′ via a turn buckle assembly 394 which includes threaded rods 400 fixedly mounted into the opposed ends of first and second bars 384, 384′, and adjustment handle 396. The opposite end of second bar 384′ is pivotally mounted along side of a frame rail of trolley frame 140, at pivot 392. Alternative support element 380 folds at pivot 398, to effectively fold in half as turn buckle assembly 394 and bars 384 and 384′ nest inside of U-shaped channel 382. Thus, when deck assembly 100 is folded downward to be adjacent trolley frame 140, support element 380 is able to nest along and between frame rails of deck assembly 100 and trolley frame 140.

When deck assembly 100 is pivoted upward toward a use position, folded support element 380 may be moved downward near its center, so that U-shaped channel 382 and the lower bar and turn buckle assembly 394 may be pivoted at pivot 398 to attain an extended position. In this extended position, handle 396 of turn buckle assembly 394 may be rotated to adjust the angle of deck assembly 100. After achieving the desired angular position of deck assembly 100, a collar 402 is slidably moved to a locking position over pivot 398 and turn buckle handle 396, until it reaches a stop protrusion 404 on bar 384′, as shown in phantom in FIG. 14. This locking position of collar 402 prevents inadvertent folding or other adjustment of support element 380.

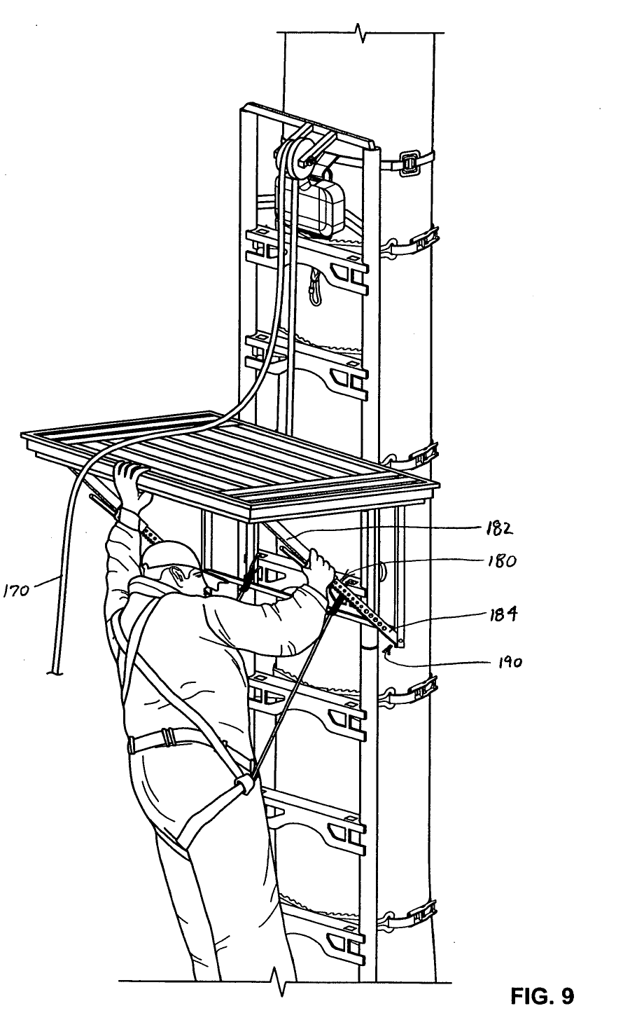

To enhance the safety of a user in moving from ladder assembly 12 to the platform assembly 14, platform assembly 14 also incorporates a door assembly 120, as shown in FIG. 10. Door assembly 120 may incorporate a number of different structures. These structures may include single or multiple doors, which pivot, slide or lift out of their normal use position so as to create an opening 122 through deck assembly 100. Door assembly 120 is shown in the preferred embodiment as being constructed of a pair of doors 124, 126 which are pivotally connected to each other at pivots 128. In turn, door 124 is pivotally connected at pivots (not shown) to outer frame 110 of deck assembly 100. This structure creates a bi-fold door assembly 120 which may easily be opened by grasping door 126 and pushing upward near pivots 128 while also pushing toward the front of outer frame 110, so as to simultaneously fold door assembly 120 and slide it to an open position.

After the user has climbed the ladder and placed the platform in a relatively horizontal position for use, bi-fold door assembly 120 may be pivoted to an open position to expose opening 122 in deck assembly 100. As shown in FIG. 10, this will then permit the user to further climb ladder assembly 12, without having to climb around or over the side of platform assembly 14. Deck assembly 100 of platform assembly 14 preferably has side deck surfaces 123 that extend outward from opening 122 to the sides of outer frame 110. These areas allow the user to climb ladder assembly 12 upward through opening 122, and to step onto deck assembly 100 to either side of opening 122. The user then may close door assembly 120 to complete the floor surface of platform assembly 14.

Thus, deck assembly 100 may be pivotally connected to trolley 104 and held in a use position by one of the previously mentioned support elements 180, 280 or 380, or the like. For added safety and stability, after deck assembly 100 is placed in a use position, platform assembly 14 also may be separately connected to the tree T or other substantially vertical columnar structure such as a pole, by using another binding system which may, for example, include using hook receiving slots 116, shown in FIG. 7, on the sides of trolley frame 104 and an adjustable length flexible assembly 80 comparable to that used to connect and bind ladder assembly 12 to tree T.

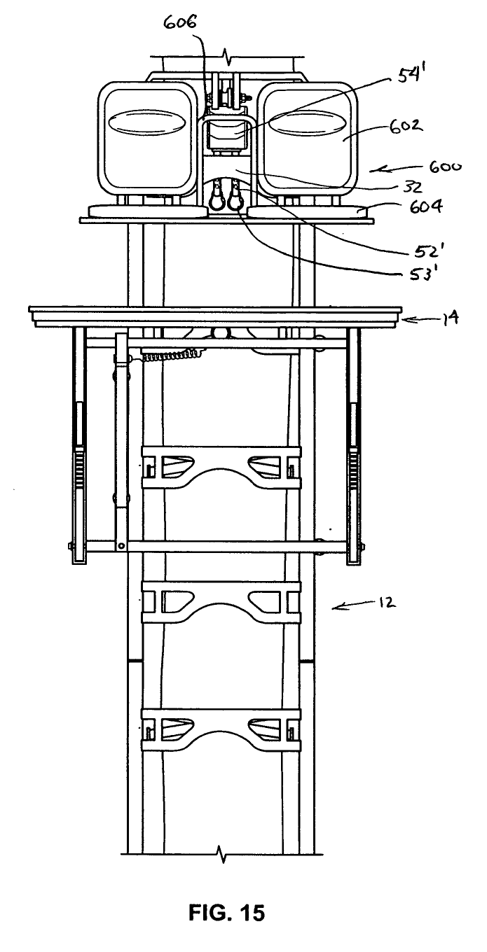

Seating may be employed with the ladder stand of the present invention in various forms. As seen in FIG. 15, a two person seat assembly 600 is shown located just above platform assembly 14. Seat assembly 600 has a pair of seat backs 602 and a pair of seat bottoms 604. A seat frame assembly 606 is used to join the seat backs 602 and the seat bottoms 604, and to connect the assembly to ladder assembly 12. Seat assembly 600 may be plugged into rung holes 44 in ladder rung 32 with mounting pins (not shown), or otherwise removably secured to ladder assembly 12. Also, belt retractor 54′ may be configured to provide two independent fall arrest belts 52′ with connectors 53′ for connection to the respective safety harnesses of two users.

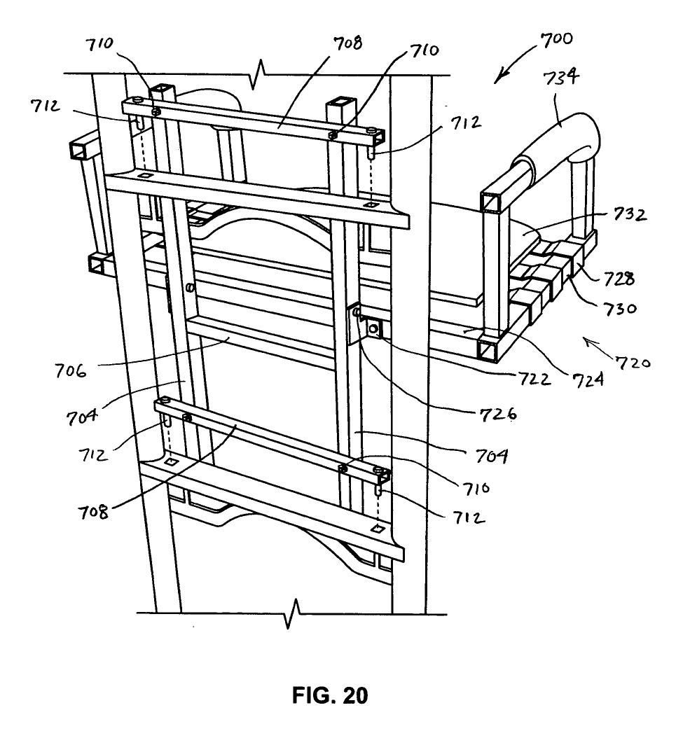

As simplified version of the preferred single person seat for the first embodiment is shown in FIG. 20. The seat assembly 700 includes a back frame assembly 702 with a pair of vertical rails 704 connected by a central horizontal rail 706, such as by welding, and also connected by a pair of horizontal rails 708, such as by at fasteners 710. Each horizontal rail 708 has a pair of downward projecting pins 712 which are in vertically and horizontally spaced alignment to engage a pair of rung holes 44 in a pair of successive rungs 32. A seat bottom assembly 720 includes a pair of brackets 722 projecting rearwardly from rear seat rail 724 and being pivotally connected to back frame assembly 702 at pivots 726. Seat bottom assembly 720 may be constructed in many ways to provide a light weight, comfortable seat, such as is shown with webbing 728 strung between bottom side rails 730 which are connected to rear seat rail 724, and including a seat pad 732 and upstanding arm rests 734.

It will be appreciated that seat assemblies may be constructed using suitable materials, such as steel tubing or the like, as well as webbing or pad materials, as desired. Also, connections between rails may be made by welding or use of fasteners, such as bolts, or the like, and attachment of webbing or pads may be by fasteners, adhesives or the like.

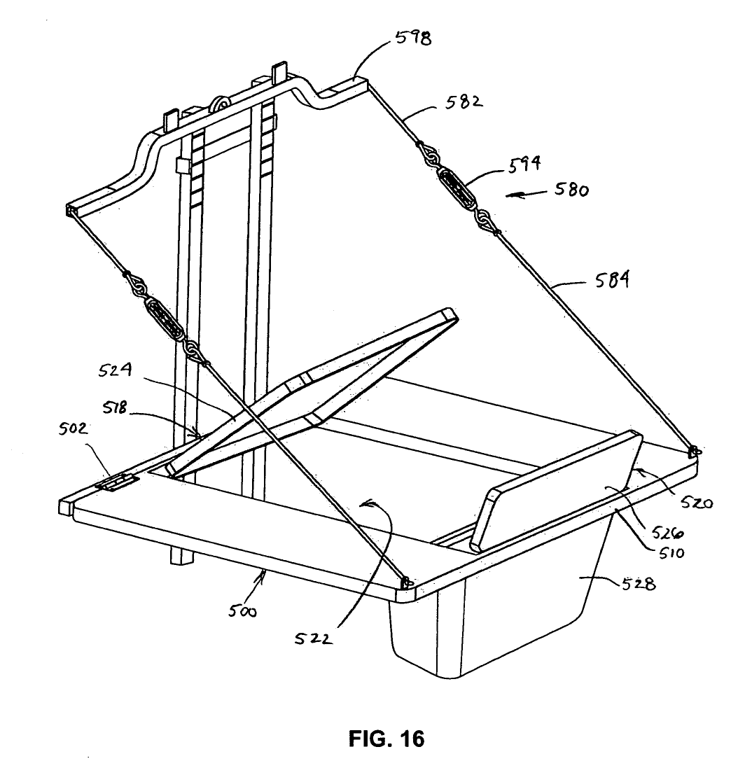

It will be appreciated that platform assembly 14 is one example of a configuration that is consistent with the invention, but that alternative platform assembly configurations are possible. For instance, another example is shown in FIG. 16 with a more simplified schematic representation of a trolley frame 540, and a deck assembly 500, which are pivotally connected at pivots 502 on a lower support rail of trolley frame 540. Thus, in this configuration, deck assembly 500 pivots downward to a use position. As such, deck assembly 500 may be supported by flexible tensile elements 580. Flexible elements 580 preferably would be constructed with lower cable portions 584, each connected to deck assembly 500 at a first end, and then connected at a second end to a turn buckle assembly 594, with the two turn buckle assemblies 594 also connected to each other by an intermediate cable portion 582. In the embodiment shown, intermediate cable portion 582 passes through an upper support rail 598 of trolley frame 540. It will be appreciated that trolley frame 540 is a schematic representation of a basic portion of the structure for a trolley assembly that may be adapted, as with aforementioned trolley 104, to engage a ladder assembly 12.

Alternative deck assembly 500 further presents potential alternative door assemblies 518 and 520 which may be pivoted to cover an opening 522 through deck assembly 500. In this embodiment, a first door 524 is preferably pivotally connected to an outer frame 510 near the rear of deck assembly 500, and is a primary door that permits the user to pass through the platform assembly while ascending ladder assembly 12 after the platform assembly positioned at a desirable height. Once passing through door 524, the user could step to either or both sides of opening 522 while maneuvering to lower door 524. Second door 526 also is preferably pivotally connected to outer frame 510, but near the front of deck assembly 500. Second door 526 is shown as a cover for an optional storage container 528. With this alternative configuration, flexible elements 580 merely bend and fold, creating an upward opening loop when deck assembly 500 is folded upward to be adjacent trolley frame 540.

With any of the afore-mentioned support element assemblies, it will be appreciated that the process may be reversed if it is desired to pivot deck assembly 100 or 500 back to a substantially vertical position adjacent trolley frame 140 or 540, respectively.

A further exemplary embodiment is of a ladder stand 800 consistent with the present invention is shown in FIGS. 18 and 19. This embodiment includes a ladder assembly 812 having a single central vertical stile or ladder rail 830, which may be a single section or a plurality of sections joined such as by pins 838. Ladder assembly 812 further includes ladder steps 832 connected to ladder rail 830 with fasteners 831, or such as by welding. Steps 832 have holes 844 on treads 836.

Ladder stand 800 also included a platform assembly 814, somewhat similar to that of the first embodiment and having a trolley assembly 804 and a deck assembly 900 pivotally connected to trolley assembly 904 at pivots 902. Platform assembly 814 includes a sliding door 920 which defines an opening 922 in deck assembly 900. Trolley assembly includes rollers 942 and a similar pivotal arm construction to the first embodiment for engaging a roller track 933 on each respective side of stile 830. Platform assembly 824 also includes adjustable support mechanisms 980 to hold deck assembly 900 at a desired angular position relative to trolley assembly 904.

As shown, ladder stand 800 also includes latching mechanisms 958 to be able to hoist platform assembly 814 along ladder assembly 812 and latch it into position at a desired height by engaging holes 844 in steps 832 with locking tabs 962. Ladder stand 800 further includes a belt retractor 854 mounted to a stile cap 856, and a pulley 872 pivotally connected to arms 874. Of further note, ladder stand 800 is shown with an alternative connection arrangement for seat assembly 880. Seat assembly 880 is hung by latching hooks 882 which engage step holes 844 in a pair of laterally spaced steps 832.

Turning now to the method of assembling an exemplary ladder stand of the present invention. One will appreciate that the invention enables an individual user to assemble and use a ladder stand 10 adjacent a columnar structure, such as a tree or a pole, in highly advantageous ways. To assemble ladder stand 10, the user prepares a ladder assembly adjacent a ground surface. The ladder assembly may be of a single section, or may include a plurality of sections, as shown in the preferred embodiment. With reference to the preferred embodiment, the user joins ladder sections, such as sections 16, 18 and 20, in an end to end manner to form a ladder assembly 12 having a plurality of tree engaging spacers 60. The user makes a preliminary adjustment of spacers 60, to estimate the stand-off distance that ladder stand 10 should be placed from the tree T for each spacer 60 along the length of ladder assembly 12. The user then raises ladder assembly 12 by grasping the upper end and raising it further upward while walking ladder assembly 12 to an upright position adjacent and in contact with the tree T.

Once upright, the user engages a plurality of binding systems to bind ladder assembly 12 to the tree T at two or more positions along ladder assembly 12. Spacers 60 may be readjusted inward or outward by resetting pin 72 in respective adjustment apertures 70 in arms 64 as needed to account for deviations in the trunk of tree T. The user initially binds the lowest ladder section 16 and then continues to bind ladder assembly 12 to tree T at successively higher spacer locations. In this way, the user is able to operate from a secure structure as he moves upward, and may place hooks 48 of safety lines 46 in rung holes 44 to ensure safety from falling while continuing to climb and bind successive spacers 60 of ladder assembly 12. Safety lines 46 tethering the user's harness 42 to ladder assembly 12 permits the user to lean back into harness 42 and thereby have the user's hands free to manipulate the binding systems 80 to removably connect ladder assembly 12 to tree T.

After the user has bound ladder assembly 12 to tree T, the user installs platform assembly 14 to ladder assembly 12 by engaging trolley assembly 104 with respective ladder stiles 30. Note, however, as an option, the platform and trolley system could be mounted to the bottom-most ladder section when in a lowered position in a manner that is not readily removable, as opposed to being removable from ladder assembly 12.

With ladder assembly 12 connected to tree T, platform assembly 14 may be raised using a flexible element, such as rope 170, strung up and over pulley 172 attached to the upper end of ladder assembly 12 and running back down to be attached to trolley assembly 104 at one end, while having the other end free to be grasped by the user. By pulling downward on the free section of rope 170, the user may raise platform assembly 14 and engage trolley assembly 104 via rung lock mechanisms 158 at any desired rung height.

The user then climbs ladder assembly 112, pivots the deck assembly 100 of platform assembly 14 upward and into a relatively horizontal position and engages support elements 180 to maintain the desired horizontal position. For added safety and stability, after deck assembly 100 is placed in a use position, the user preferably separately binds platform assembly 14 to the tree T or other columnar structure using hook receiving slots 116 on the sides of trolley frame 104. The user then slides door assembly 120 toward the forward edge of deck assembly 100, thereby exposing opening 122 in the platform. The user climbs ladder assembly 12 further and steps through opening 122 and onto one or more of the side deck surfaces 123. The user then closes door assembly 120, and now is in a position to perform whatever activity is desired on top of the platform, whether it be hunting, performing maintenance, or otherwise.

While on top of the platform, the user may connect harness 42 to a belt retractor 54 by connecting retractable belt 52 to harness 42 with connector 53. Belt retractor 54 permits the user to climb up and down ladder assembly 12 and move within a predetermined distance of the retractor.

It will be appreciated that the user may alternatively build the ladder stand 10 from the ground surface upward, one ladder section at a time. With the present invention, each ladder section may be securing bound to the columnar structure and the user may be safely tethered to a secured ladder section as the user lifts a further ladder section into place, atop the already secured section. This procedure may be repeated until the desired ladder assembly height is attained, at which time the platform assembly may be connected and hoisted into place, following the remainder of the above-mentioned method of assembly to completion.

What is claimed is:

1. A ladder assembly comprising:
at least one ladder section, said ladder section further comprising:
two spaced apart, substantially parallel stiles;
a plurality of spaced apart rungs spanning between and connected to the respective two spaced apart stiles; and
each rung having a configuration that further comprises at least a tread portion, a rear support portion connected to the tread portion and connected to the stiles, and a front portion connected to the tread portion and having two pair of separate spaced apart tab portions with each pair being connected to a different one of the respective stiles.

2. A ladder assembly in accordance with claim 1, wherein the front portion of the rung is generally in a cross-shape.

3. A ladder assembly in accordance with claim 1, wherein the tread portion of each rung provides a surface for employing traction enhancement measures.

4. A ladder stand assembly comprising:
a ladder assembly;
a platform assembly;
the platform assembly further comprising a trolley assembly having a frame substantially parallel to the ladder assembly and being pivotally connected to a deck assembly;
the trolley assembly slidably engaging the ladder assembly and being configured to be hoisted upward along and the ladder assembly; and
the platform assembly having a locking assembly to adjust the position of the platform assembly relative to the ladder assembly.

5. A ladder stand assembly in accordance with claim 4, wherein at least one adjustable support member is used in setting an angle between the trolley assembly and the deck assembly.

6. A ladder stand assembly in accordance with claim 4, wherein the ladder assembly further comprises a plurality of rung portions and the platform assembly locking assembly further comprises a plurality of locking mechanisms configured to removably engage the rung portions.

7. A ladder stand assembly in accordance with claim 4, wherein the ladder assembly further comprises at least one ladder section having at lease two ladder stiles, and a plurality of spaced apart rungs, with each rung spanning between the stiles.

8. A ladder stand assembly in accordance with claim 4, wherein the trolley assembly further comprises at least two rollers and each roller engages at lease one respective stile.

9. A ladder stand assembly in accordance with claim 4, wherein the deck assembly further comprises a sight level connected along an underside of the deck assembly and responsive to angular adjustment of the deck assembly.

10. A ladder stand assembly comprising:
a ladder assembly having a length;
a platform assembly;
the platform assembly removably connectable to the ladder assembly and adjustable to a plurality of positions along the length of the ladder assembly; and
the platform assembly further comprising a deck assembly having a deck surface and an opening in the deck surface coverable by a door assembly, wherein the door assembly is movable between a closed position and an open position to permit access to the deck surface through the opening.

11. A ladder stand assembly in accordance with claim 10, wherein the door assembly further comprises a bi-fold door assembly with a first door and a second door, the first door being pivotally connected to the deck assembly and the second door being pivotally connected to the first door, wherein the bi-fold door assembly is slidably and pivotally movable between the closed and open positions.

12. A ladder stand assembly in accordance with claim 10, wherein the door assembly further comprises at least one sliding door movable between the closed and open positions.

13. A ladder stand assembly in accordance with claim 10, wherein the door assembly further comprises at least two separate doors with each being pivotally connected to the deck assembly in a fore or aft direction relative to the ladder assembly, and the deck assembly having a portion of the deck surface disposed laterally relative to the opening in the deck surface.

14. A ladder assembly comprising:
at least one ladder section having a length and a plurality steps located in a first plane and a plurality of spacer assemblies arranged along the length of the ladder section and extending away from the first plane; and
each spacer assembly further comprising a pair of pivotally adjustable arms movable to at least two positions in which the arms are oriented in crossed configurations relative to each other, wherein each arm intersects the respective path of the other arm and the two positions establish at least two spacer adjustment settings having different distances between first plane and the intersection of the crossed arms.

15. A ladder stand assembly in accordance with claim 14, wherein the spacers are adjustable to permit the ladder assembly to engage a columnar structure at locations of the spacer assemblies along the length of the ladder assembly.

16. A ladder stand assembly in accordance with claim 14, wherein each arm further comprises an engagement portion having a roughened surface.

17. A ladder stand assembly in accordance with claim 14, wherein each pair of adjustable arms further comprises an adjustment mechanism that engages the arms and holds them in a crossed configuration relative to each other.

18. A ladder assembly with a fall arrest system comprising:
a user climbing harness having at least one tether line extending from the harness and having a fastener at the distal end of the tether line;
at least one ladder section, the ladder section further comprising:
at least one ladder stile;
a plurality of spaced apart ladder steps connected to the at least one ladder stile;
the at least one ladder section having a length and further comprising fastener engaging positions along its length that receive at least one tether line fastener; and
wherein a user wearing the climbing harness is able to engage the at least one tether line fastener with successive fastener engaging positions on the at least one ladder section while ascending or descending the ladder section.

19. A ladder assembly with fall arrest system in accordance with claim 18, wherein the tether line fastener at the distal end of the at least one tether line is adapted to engage apertures in the plurality of ladder steps.

20. A ladder assembly with fall arrest system in accordance with claim 18, wherein the tether line fastener at the distal end of the at least one tether line is adapted to engage a plurality of eyelets formed on the ladder section along its length.

21. A ladder assembly with fall arrest system in accordance with claim 18, further comprising a fall arrest belt retractor connected to the ladder section proximate an upper end of the ladder section, the belt retractor further comprising a length of safety belt with a releasable fastener at a distal end of the safety belt, the releasable fastener being connectable to the user's climbing harness.

22. A method of assembling a ladder stand assembly, comprising the steps of:
connecting a plurality of ladder sections having spacer assemblies and steps to form a ladder assembly having a length along a ground surface;
making preliminary adjustments to the spacer assemblies on the ladder assembly;
connecting binding assemblies to the ladder assembly to permit connection to a columnar structure;
moving the ladder assembly from along the ground surface to a relatively vertical position immediately adjacent the columnar structure;
binding the ladder assembly to the columnar structure with the binding assemblies that are reachable by a user from the ground surface;
climbing the ladder assembly while removably connecting a harness worn by the user to the ladder assembly to reach successively higher binding positions and to further bind the ladder to the columnar structure at all successively higher positions;
descending the ladder assembly;
connecting to the ladder assembly a platform assembly having a trolley assembly pivotally connected to a deck assembly, and wherein the trolley assembly is slidably engaged with the ladder assembly;
hoisting the platform assembly to a desired height corresponding to a height of one of the steps;
climbing the ladder assembly and pivoting the deck assembly relative to the trolley assembly and connecting at least one support mechanism to maintain one or more angular positions of the deck assembly relative to the trolley assembly;
adjusting the support mechanism to achieve a desired angular position of the deck assembly relative to the trolley assembly; and
separately binding the platform assembly to the columnar structure with a binding assembly.

23. The method of assembling a ladder stand assembly in accordance with claim 22, wherein the deck assembly further comprises a door assembly which is movable to an open position, comprising the further steps of:
moving the door assembly to an open position wherein an opening is defined in the deck assembly;
further climbing the ladder assembly and passing through the opening in the deck assembly; and
moving the door assembly to a closed position wherein the opening in the deck assembly is covered by the door assembly.
